(19) United States
(12) Patent Application Publication
(10) Pub. No.: US 2017/0237704 A1
(43) Pub. Date: Aug. 17, 2017

(54) ADDRESSING COMMUNICATION METHOD AND ELECTRONIC DEVICE BASED ON MEDIA ACCESS CONTROL ADDRESS

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventor: Rongquan Xiao, Tianjin (CN)

(21) Appl. No.: 15/249,699

(22) Filed: Aug. 29, 2016

Related U.S. Application Data
(63) Continuation of application No. PCT/CN2016/088723, filed on Jul. 5, 2016.

(30) Foreign Application Priority Data
Feb. 16, 2016 (CN) 201610087096.9

(51) Int. Cl. H04L 29/12

(52) U.S. Cl. CPC H04L 61/2007; H04L 61/6022; H04L 61/2069

(57) ABSTRACT

This disclosure discloses an addressing communication method and electronic device based on a media access control address. The method includes: a first device sets a UID of the first device according to its MAC address, and stores an association relation between respective description information, including the UID, of the first device; when intercepting a query request, used to query an IP address, of a second device, determines whether the MAC address of the first device is a MAC address, included in the query request, of a to-be-queried device; if yes, transmits an IP address of the first device to the second device so that the second device communicates with the first device according to the IP address. The disclosure may simplify related operations of configuring and maintaining the UID, lower configuration and maintenance costs, and decrease the risk of failures in a system without affecting communications.

### CROSS REFERENCE TO RELATED APPLICATIONS

This application is a continuation of International Application No. PCT/CN2016/088723 submitted on Jul. 5, 2016, which claims priority to Chinese Patent Application No. 201610087096.9 entitled “ADDRESSING COMMUNICATION METHOD AND ELECTRONIC DEVICE BASED ON MEDIA ACCESS CONTROL ADDRESS”, filed before China's State Intellectual Property Office on Feb. 16, 2016, the entire contents of which are incorporated herein by reference.

### TECHNICAL FIELD

The disclosure belongs to the technical field of interconnection of smart homes, and particularly relates to an addressing communication method and electronic device based on a media access control address.

### BACKGROUND

In a P2P (Peer-to-Peer) push-to-image and push-to-talk system of a smart home, each physical device (such as an indoor machine, an entrance machine, a monitor machine and the like) has a unique identifier (UID), this identifier is used to identify, recognize and find the physical device, and performs network communication and information interaction with it. This UID generally consists of a combination of letters and digits; in general, the device is fixed after being initialized without modification or availability of modification. Meanwhile, it is guaranteed that this UID has device uniqueness, without a case where two devices have the UID value. Meanwhile, basic information required by network communications can be mapped or calculated by this UID. Therefore, the basic information such as an internet protocol (IP) address realizes a final purpose of information interaction; otherwise, this UID has no practical significance.

At present, an existing solution is that setting the UID for the device is based on static binding of the IP address, that is, the IP address and the UID form a one-to-one correspondence relationship, other cases where a non-IP address is transformed by a local database or server database are finally cases where the non-IP address is transformed into the IP address, which may be treated as the same case where the UID and the IP address are statically bound.

However, the above solution has the following technical problem: the IP address of the device is required to be fixed. If the IP address is manually set, there is a heavy workload in installing and debugging for a large batch of devices, and it is difficult to guarantee that no repeated IP addresses are generated, and thereby the devices with repeated IP addresses cannot normally work; if the IP address is automatically assigned, there is a need for making assignment binding configured to add a media access control (MAC) address to the IP address on an IP address assignment server; because IP assignment software of a server is not uniform or is limited in support degree, the whole system is difficult to completely and effectively integrate together. When moving the device to a physical position of another network-across segment results in a case of having to modify the IP address of the device for making device debugging, configurations of a background database and the IP allocation software of the server are required to be modified for performing normal network communication, and a process is very tedious. Further, when the IP address is manually set, there is a need for considering how to avoid the IP address conflict, because positioning a fault when the IP address conflicts remains a challenge, manually setting the IP address increases a system risk. On the other hand, it may be conventionally seen that a fixed IP address of one device is illogical, because the IP address is a shared resource and does not belong to a certain specific device, and the varying IP address does not facilitate the historical tracking of the device.

### SUMMARY

The disclosure provides an addressing communication method and electronic device based on a media access control address, which are used to perform binding setting on a MAC address and a UID of a device, find a corresponding IP address based on the MAC address of the device, and perform communication according to the IP address, so that on a premise of no impact on communications, related operations of configuring and maintaining the UID may be simplified, the configuration and maintenance costs are lowered, and the risk of failure in the system is decreased.

The disclosure provides an addressing communication method based on a media access control address, including:

a first device receives a binding instruction, and sets a unique identifier of the first device according to a media access control address of the first device in accordance with the binding instruction;

the first device stores an association relation between respective description information, including the unique identifier, of the first device;

when intercepting a query request, used to query an internet protocol address, of a second device, the first device determines whether the media access control address of the first device is a media access control address, included in the query request, of a to-be-queried device; and

if yes, the first device transmits the internet protocol address of the first device to the second device so that the second device communicates with the first device according to the internet protocol address.

In another aspect, the embodiments of the disclosure also provide a nonvolatile computer storage media having computer executable instructions stored thereon, wherein the computer executable instructions can execute any one of the foregoing addressing communication method based on a media access control address in the disclosure.

In further another aspect, the embodiments of the disclosure further provide an electronic device, including: one or more processors; and a memory; wherein, the memory is stored with instructions executable by the one or more processors, the instructions are configured to execute any one of the foregoing addressing communication method based on a media access control address in the disclosure.

It may be known from the embodiments of the disclosure that according to the addressing communication method and electronic device based on a media access control address, which are provided by the disclosure, the MAC address of the device is used as a UID, such that the UID of the device is unique; and the problems that the maintenance cost is high, assigning the IP address easily goes wrong and the system is easily susceptible to failure when the IP address is associated with the UID of the device in the prior art are solved due to unchangeability of the MAC address. Meanwhile, by intercepting a query request, transmitted by other devices, of querying the IP address, and returning the IP address of the device, a normal communication may be kept among the devices, in this way, on the basis of keeping the normal communication, related operations of configuring and maintaining the UID of the device may be simplified, the configuration and maintenance costs are lowered, and the risk of failures in the system is decreased.

### BRIEF DESCRIPTION OF THE DRAWINGS

To more clearly illustrate the technical solution in the embodiments of the disclosure or in the prior art, the following will briefly introduce the accompanying drawings to be used in the description of the embodiments or the prior art. It is apparent that the accompanying drawings in the following description are merely illustrative of some embodiments of the disclosure, and other accompanying drawings may be obtained by those ordinarily skilled in the art without paying inventive efforts.

FIG. 1 is a schematic diagram of a structure of a push-to-image and push-to-talk control system of a smart home according to an embodiment of the disclosure.

FIG. 2 is a schematic diagram of an implementation process of an addressing communication method based on a media access control address according to a first embodiment of the disclosure.

FIG. 3 is a schematic diagram of an implementation process of an addressing communication method based on a media access control address according to a second embodiment of the disclosure.

FIG. 4 is a schematic diagram of a communication structure among a first device, a second device and a server according to an embodiment of the disclosure.

FIG. 5 is a schematic diagram of a structure of an addressing communication apparatus based on a media access control address according to a third embodiment of the disclosure.

FIG. 6 is a schematic diagram of a structure of an addressing communication apparatus based on a media access control address according to a fourth embodiment of the disclosure.

FIG. 7 is a schematic diagram of a structure of a hardware of the device of the addressing communication method based on a media access control address according to another embodiment of the disclosure.

### DETAILED DESCRIPTION

To make the objects, features and advantages of the disclosure be more obvious and easy to understand, the technical solution in the embodiment of the disclosure will be completely and clearly described below in conjunction with the accompanying drawings in the embodiments of the disclosure. It is apparent that the embodiments described are merely illustrative of some, but not all embodiments of the disclosure. Based on the embodiments in the disclosure, all other embodiments obtained by those skilled in the art without paying inventive efforts all belong to a protective scope of the disclosure.

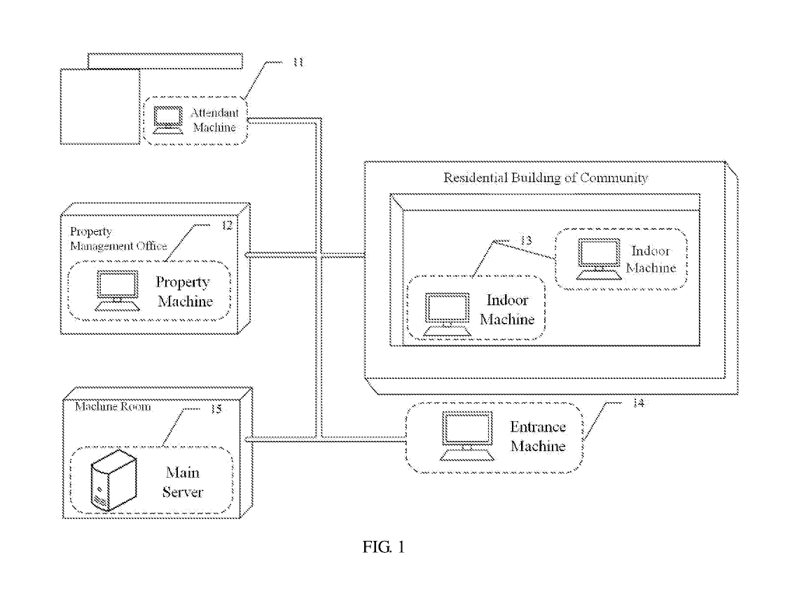

An embodiment of the disclosure provides an addressing communication method based on a media access control address, which may be applied to a push-to-image and push-to-talk control system of a smart home. The push-to-image and push-to-talk control system of the smart home is generally disposed inside a residential community. With reference to FIG. 1, FIG. 1 is a schematic diagram of a structure of a push-to-image and push-to-talk control system of a smart home. The system includes:

an attendant machine 11 disposed at an attendant room of the residential community, a property machine 12 disposed at a property management office of the residential community, an indoor machine 13 disposed in each house of a residential building of the residential community, an entrance machine 14 disposed outside the residential building of the residential community and a main server 15 disposed in a machine room, all the above devices are connected through a network, and the network may be a local area network, or may also be Internet; and all devices may be communicated through the network.

In particular, the indoor machine 13 and the entrance machine 14 may at least perform push-to-image and push-to-talk through a screen, and perform the next operation, such as opening a unit gate corresponding to the entrance machine 14, as well as opening a resident gate corresponding to the indoor machine 13. As needs arise, for example, when a resident cannot open his or her own gate or a unit gate because a key is forgotten and nobody is at home, or because the indoor machine 13, the entrance machine 14, the resident gate or unit gate suffers a mechanical failure, he or she calls or connects the attendant machine 11 or the property machine 12, the attendant machine 11 or the property machine 12 may also perform push-to-image and push-to-talk with the indoor machine 13 or the entrance machine 14 through the screen, so as to help the resident open the corresponding gate. The main server 15 is configured to store user information, including information such as a user photo and a specific residential address.

It is to be noted that, the devices such as the attendant machine 11, the property machine 12, the indoor machine 13 and the entrance machine 14 shown in FIG. 1 are the first device and the second device in the embodiments of the disclosure, they may be fixed devices, or may also be mobile devices, for example, the attendant machine 11 may be a device fixed in the attendant room, or may be a handheld device of an attendant, so as to facilitate communicating with other devices by using the handheld device when the attendant moves within a certain range.

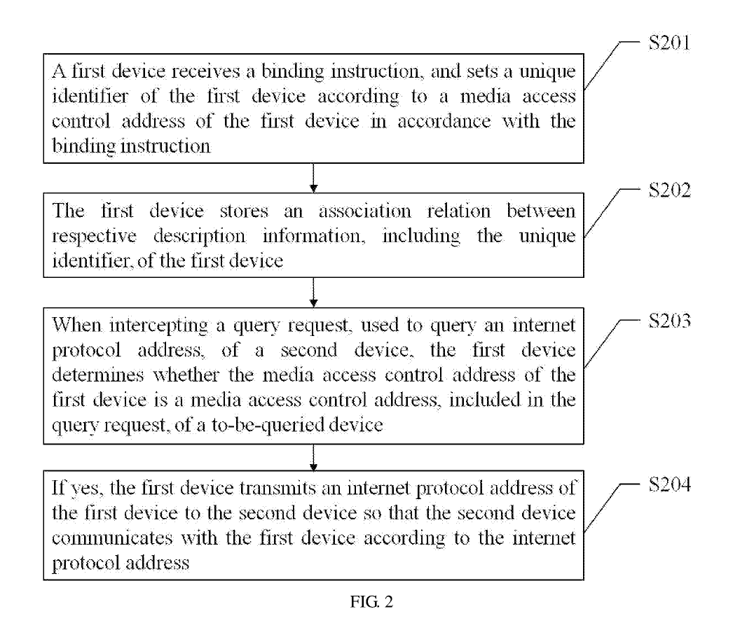

With reference to FIG. 2, FIG. 2 is a schematic diagram of an implementation process of an addressing communication method based on a media access control address according to a first embodiment of the disclosure. The addressing communication method may be applied to devices shown in FIG. 1 and mainly includes the following steps:

S201. A first device receives a binding instruction, and sets a unique identifier of the first device according to a media access control address of the first device in accordance with the binding instruction.

The first device may be any one of devices such as an attendant machine 11, a property machine 12, an indoor machine 13 and an entrance machine 14 in FIG. 1.

A unique identifier UID is firstly set for the first device. A setting person inputs the binding instruction, and the first device receives the binding instruction, and sets the UID of the first device according to the MAC address of the first device in accordance with the binding instruction to make the UID be associated with the MAC address, such that the UID becomes a unique identifier of the first device.

S202. The first device stores an association relation between respective description information, including the unique identifier, of the first device.

The association relation between the respective description information of the first device is stored in the first device, the description information refers to information of describing various aspects of attributes of the first device, for example, the description information may be UID information of the first device, or may also be number information used to mark a physical position where the first device is located, or may be specific address information of the first device, and the address information may be specific to a number of a room where the first device is located.

The association relation refers to a correspondence relationship among the UID information, the number information and the address information of the first device. The association relation may be stored in the first device in a form of an association relationship diagram, as shown below:

| | | | Build- | | | |
|---|---|---|---|---|---|---|
| | Num- | Nick- | ing | Unit | | Room |
| Device UID | ber | name | Number | Number | Floor | Number |
| 001023487F6B | 0110501 | 1-1-501 | 1 | 1 | 5 | 501 |
| | | Resi- | | | | |
| | | dent | | | | |

It may be seen from the information in the Figure that, since the diagram does not include IP address information, the association relationship diagram has not to be modified regardless of whether the IP address of the first device is of a custom IP setting or an automatic IP setting. In particular, if a manner of acquiring the IP address by the first device is set to automatically acquire the IP address, when the first device is moved from one physical network to another physical network, any other configuration information has not to be modified, and installation, use and maintenance of the device are simplified.

S203. When intercepting a query request, used to query an internet protocol address, of a second device, the first device determines whether the media access control address of the first device is a media access control address, included in the query request, of a to-be-queried device.

The device is required to acquire an IP address of a correspondent device if communicating with other devices, and thus to transmit a query request of the IP address to the correspondent device. Correspondingly, to acquire the query request, one background service runs on each device, and is used to intercept the query request of the IP address from a designated port (such as a port 10010).

The second device transmits the query request of querying the IP address, and the MAC address of the to-be-queried device is carried in the query request, and the to-be-queried device is a correspondent device to be communicated with the second device. When the first device intercepts the query request, used to query the IP address, of the second device, it determines whether the MAC address of the first device is the MAC address in the query request.

The second device may be any one of devices such as an attendant machine 11, a property machine 12, an indoor machine 13 and an entrance machine 14 in FIG. 1, and may be communicated with the first device.

S204. If yes, the first device transmits the internet protocol address of the first device to the second device so that the second device communicates with the first device according to the internet protocol address.

If the first device determines that the MAC address of the first device is the MAC address of the to-be-queried device, it transmits the IP address of the first device to the second device, such that the second device may communicate with the first device according to the IP address transmitted by the first device.

If the first device determines that the MAC address of the first device is not the MAC address of the to-be-queried device, the first device disregards it, and continuously intercepts at this port until intercepting the next query request of querying the IP address.

In the embodiment of the disclosure, the MAC address of the device is used as a UID, such that the UID of the device is unique; and the problems that the maintenance cost is high, assigning the IP address easily goes wrong and the system is easily susceptible to failure when the IP address is associated with the UID of the device in the prior art are solved due to unchangeability of the MAC address. Meanwhile, by intercepting a query request, transmitted by other devices, of querying the IP address, and returning the IP address of the device, a normal communication may be kept among the devices, in this way, on the basis of keeping the normal communication, related operations of configuring and maintaining the UID of the device may be simplified, the configuration and maintenance costs are lowered, and the risk of failures in the system is decreased.

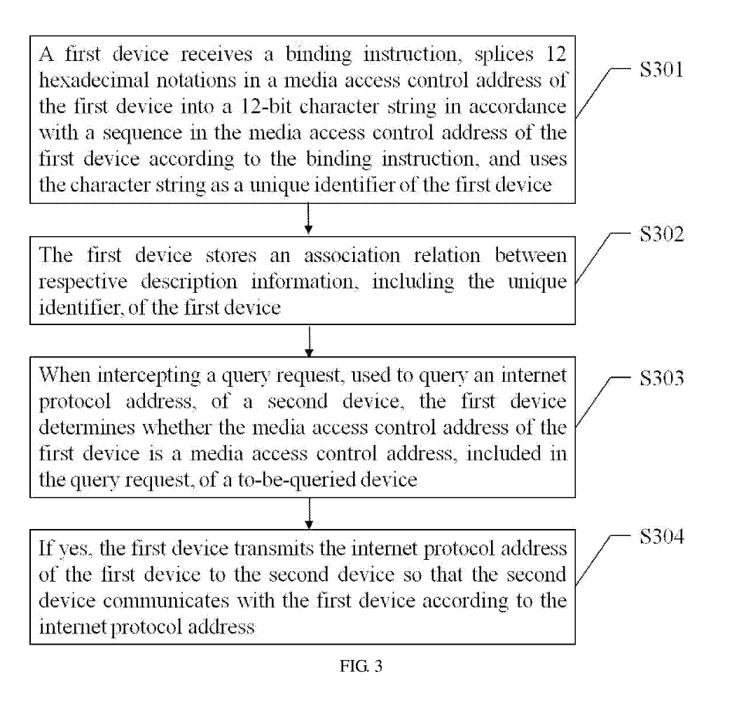

With reference to FIG. 3, FIG. 3 is a schematic diagram of an implementation process of an addressing communication method based on a media access control address according to a second embodiment of the disclosure. The addressing communication method may be applied to devices shown in FIG. 1, and mainly includes the following steps:

S301. A first device receives a binding instruction, splices 12 hexadecimal notations in a media access control address of the first device into a 12-bit character string in accordance with a sequence in the media access control address of the first device according to the binding instruction, and uses the character string as a unique identifier of the first device.

The first device may be any one of devices such as an attendant machine 11, a property machine 12, an indoor machine 13 and an entrance machine 14 in FIG. 1.

A unique identifier UID is firstly set for the first device. A setting person inputs the binding instruction, and the first device receives the binding instruction, and sets the UID of the first device according to the MAC address of the first device in accordance with the binding instruction.

It is to be noted that, a MAC address of the device is an address of a network card produced by a manufacturer, the MAC address for each device is unique, and the MAC address defines a network connection between computers, and is recorded on a hardware circuit on a network interface card. The MAC address is generally expressed as 12 hexadecimal notations, for example, the first device has the MAC address of 00:10:23:48:7F:6B, which is composed of 12 hexadecimal notations “0, 0, 1, 0, 2, 3, 4, 8, 7, F, 6, B” and 6 separators “:”.

The UID of the first device is set according to the MAC address of the first device, with a specific setting process that the 12 hexadecimal notations in the MAC address are spliced into the 12-bit character string in accordance with the sequence in the MAC address, and the character string serves as the UID of the first device, so that the uniqueness of the UID of each device may be guaranteed. For example, the first device in the above example has the MAC address of 00:10:23:48:7F:6B, and then the first device has the UID of “001023487F6B”.

S302. The first device stores an association relation between respective description information, including the unique identifier, of the first device.

The association relation between the respective description information of the first device is stored in the first device, the description information refers to information of describing various aspects of attributes of the first device, for example, the description information may be UID information of the first device, or may also be number information used to mark a physical position where the first device is located, or may be specific address information of the first device, and the address information may be specific to a number of a room where the first device is located.

The association relation refers to a correspondence relationship among the UID information, the number information and the address information of the first device.

S303. When intercepting a query request, used to query an internet protocol address, of a second device, the first device determines whether the media access control address of the first device is a media access control address, included in the query request, of a to-be-queried device.

The second device may be any one of devices such as an attendant machine 11, a property machine 12, an indoor machine 13 and an entrance machine 14 in FIG. 1, and may be communicated with the first device.

The second device transmits the query request of querying the IP address, and the MAC address of the to-be-queried device is carried in the query request, and the to-be-queried device is a correspondent device to be communicated with the second device. When the first device intercepts the query request, used to query the IP address, of the second device, it determines whether the MAC address of the first device is the MAC address in the query request.

S304. If yes, the first device transmits the internet protocol address of the first device to the second device so that the second device communicates with the first device according to the internet protocol address.

If the first device determines that the MAC address of the first device is the MAC address of the to-be-queried device, it transmits the IP address of the first device to the second device, such that the second device may communicate with the first device according to the IP address transmitted by the first device.

If the first device determines that the MAC address of the first device is not the MAC address of the to-be-queried device, the first device disregards it, and continuously intercepts at this port until intercepting the next query request of querying the IP address.

It is to be noted that, when the first device is required to communicate with a target device, it actively initiates a query for the IP address of the target device.

Particularly, a diagram of correspondence relationships of the MAC addresses and the IP addresses of the devices is cached in a local database of the first device, and last update time of the IP address is recorded in the diagram of correspondence relationships. The diagram of correspondence relationships has a format as below:

| MAC Address | IP Address | Last Update Time |
|---|---|---|
| 00:10:23:48:7F:6B | 192.168.0.2 | 2015-10-25 22:18 |

Further, an ageing period is set for an entry of the IP address in the diagram of correspondence relationships, and the ageing period is used to indicate an effective duration of a correspondence relationship between the MAC and the IP address in the diagram of correspondence relationships, for example, 5 seconds. The IP address in the diagram of correspondence relationships is directly used before the IP address ages, without initiating a query request of the IP address to other devices; and the IP address ages, which indicates that the IP address has been possibly failed relative to its corresponding MAC address, the IP address of the MAC address has to be acquired again, and the query request of the IP address is initiated to the other devices, in this way, the time may be saved, and the occupation of a network flow is decreased.

Further, when there is a need for communicating with a target device, a request of querying the IP address is transmitted to a plurality of other devices by means of a user datagram protocol (UDP) multicast, the request includes a MAC address of a to-be-queried target device, wherein UDP multicast may include UDP multicast or UDP broadcast. MAC addresses of the other devices are stored in respective devices; when a query request is transmitted to a plurality of other devices in the same group if IP addresses corresponding to the MAC addresses have to be queried, a MAC address of a to-be-queried device is carried in the request, in this way, when the to-be-queried target device intercepts this request, it determines whether the MAC address in the request is the MAC address of the target device, and if the MAC address in the request is the MAC address of the target device, the IP address of the target device is returned, and if the MAC address in the request is not the MAC address of the target device, the IP address of the target device is disregarded.

It is to be noted that, before a request of querying an IP address is transmitted to a plurality of other devices by means of a user datagram protocol multicast, whether a target IP address corresponding to the MAC address of the target device exists is queried from the pre-cached diagram of correspondence relationships between the MAC addresses and the IP addresses of the respective devices; if the target IP address corresponding to the MAC address of the target device does not exist, a request of querying the IP address is transmitted to the plurality of other devices by means of the UDP multicast; and if the target IP address exists, whether last update time of the diagram of correspondence relationships at a distance from current time is greater than a preset ageing period of the target IP address in the diagram of correspondence relationships is determined.

If the last update time is greater than the ageing period, it indicates that a correspondence relationship between the MAC address and the IP address in the diagram of correspondence relationships has been failed, a request of querying the IP address is transmitted to the plurality of other devices by means of the UDP multicast, the IP address replied by the target device is received, the IP address replied by the target device is updated into an IP address corresponding to the MAC address of the target device in the diagram of correspondence relationships, and the first device communicates with the target device by the IP address; if the last update time is not greater than the ageing period, the IP address corresponding to the MAC address of the target device is acquired from the diagram of correspondence relationships, and the first device communicates with the target device according to the acquired IP address.

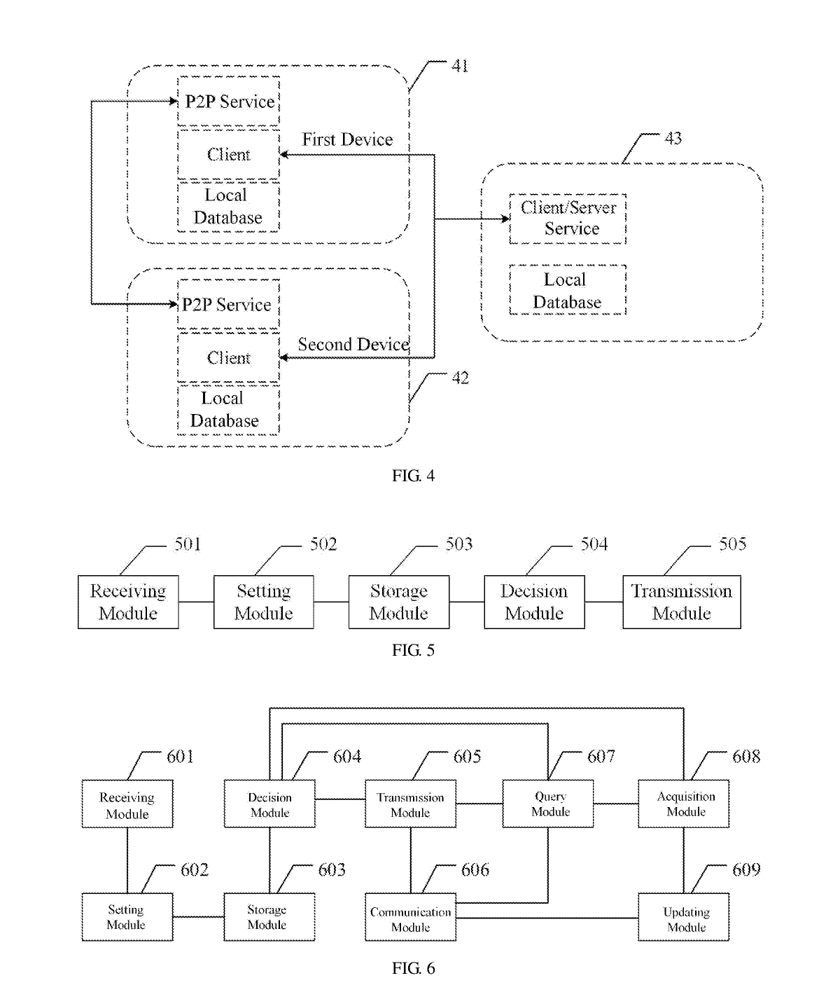

In one example, the first device and the second device are both exemplified by a LINUX system, as shown in FIG. 4. With reference to FIG. 4, a first device 41, a second device 42 and a server 43 are connected by means of a wireless or wired manner, wherein the server 43 is internally provided with a Client/Server (C/S) service module and a local database, and a C/S structure has the advantage that the processing capacity of a client device may be fully developed. The first device 41 and the second device 42 are both provided with P2P service modules, Client modules and local databases, and P2P service modules. When the first device 41 is to communicate with the second device 42, there is a need for acquiring an IP address of the second device 42, the first device 41 queries a MAC address of the second device 42 from its local database, firstly queries whether the IP address corresponding to the MAC address of the second device 42 exists in the diagram of correspondence relationships between the MAC addresses and the IP addresses cached in the local database, queries whether update time of the IP address exceeds the ageing period of the IP address if the IP address exists in the diagram of correspondence relationships, directly communicates with the second device 42 by directly using the IP address in the entry if the update time does not exceed the ageing period, initiates a query request of the IP address through multicast if the update time exceeds the ageing period, or initiates the query request of the IP address through multicast if no IP address exists in the diagram of correspondence relationships, wherein the query request is transmitted in a form of a data packet, the query request includes a MAC address of the second device 42, at this moment, all devices in the same group as the first device 41 all receive the query request.

The P2P service modules in the first device 41 and the second device 42 may intercept a UDP port pre-designated in a multicast address, the multicast port may be for example a multicast address of 239.0.0.1, or a broadcast address of 255.255.255.255, and the UDP port is for example 10010. When the multicast address is used, there is a need for calling a network subsystem to be added into a multicast group; when the broadcast address is used, there is a need for enabling broadcast receiving and transmitting characteristics of the network card. After the second device 42 receives the query request, it checks whether the MAC address requested in the data packet is identical to that of the second device 42, and if the MAC address requested in the packet is identical to that of the second device 42, returns the IP address of the second device 42 to the first device 41 in a form of a response packet, and other devices of receiving the query request check that the MAC address in the data packet is different from the MAC addresses of the other devices, and disregard it. After the first device 41 receives the response packet of the IP address of the second device 42, it analyzes the IP address of the second device 42 from the response packet, and communicates with the second device 42 by using the IP address; meanwhile, the IP address is added or updated into the diagram of correspondence relationships of the first device 41, when no IP address corresponding to the MAC address of the second device 42 exists in the diagram of correspondence relationships, the IP address is added into the diagram of correspondence relationships in a form of a new entry; and when the IP address corresponding to the MAC address of the second device 42 exists in the diagram of correspondence relationships, the IP address is updated and added into a corresponding entry in the diagram of correspondence relationships.

In the embodiment of the disclosure, the MAC address of the device is used as a UID, such that the UID of the device is unique; and the problems that the maintenance cost is high, assigning the IP address easily goes wrong and the system is easily susceptible to failure when the IP address is associated with the UID of the device in the prior art are solved due to unchangeability of the MAC address. Meanwhile, by intercepting a query request, transmitted by other devices, of querying the IP address, and returning the IP address of the device, a normal communication may be kept among the devices, in this way, on the basis of keeping the normal communication, related operations of configuring and maintaining the UID of the device may be simplified, the configuration and maintenance costs are lowered, and the risk of failures in the system is decreased. Further, an ageing period is set for the diagram of correspondence relationships, after the diagram of correspondence relationships ages, a query request of the IP address is initiated to other devices to acquire a new IP address, in this way, the time may be saved, and the occupation of a network flow is decreased.

With reference to FIG. 5, FIG. 5 is a schematic diagram of a structure of an addressing communication apparatus based on a media access control address according to a third embodiment of the disclosure. For easy of illustration, portions related to the embodiment of the disclosure are only shown. The addressing communication apparatus based on a media access control address in the example of FIG. 5 may be an executive main body of an addressing communication method based on a media access control address according to the embodiments as previously shown in FIG. 2 and FIG. 3, such as a first device or a module in the first device. The addressing communication apparatus based on a media access control address in the example of FIG. 5 mainly includes a receiving module 501, a setting module 502, a storage module 503, a decision module 504 and a transmission module 505. The above functional modules are described in detail as below.

In particular, the receiving module 501 is configured to receive a binding instruction.

The setting module 502 is configured to set a unique identifier of the first device according to a media access control address of the first device in accordance with the binding instruction.

The first device receives the binding instruction input by a setting person, and sets the UID of the first device according to the MAC address of the first device in accordance with the binding instruction to make the UID be associated with the MAC address, such that the UID becomes a unique identifier of the first device.

The storage module 503 is configured to store an association relation between respective description information, including the unique identifier, of the first device.

The association relation refers to a correspondence relationship among UID information, number information and address information of the first device.

The description information refers to information of describing various aspects of attributes of the first device, for example, the description information may be UID information of the first device, or may also be number information used to mark a physical position where the first device is located, or may be specific address information of the first device, and the address information may be specific to a number of a room where the first device is located.

The relevance information may be stored in the first device in a form of an association relationship diagram, and the association relationship diagram has a format as shown below:

| | | | Build- | | | |
|---|---|---|---|---|---|---|
| | Num- | Nick- | ing | Unit | | Room |
| Device UID | ber | name | Number | Number | Floor | Number |
| 001023487F6B | 0110501 | 1-1-501 | 1 | 1 | 5 | 501 |
| | | Resi- | | | | |
| | | dent | | | | |

It may be seen from the information in the above table, since the diagram does not include IP address information, the association relationship diagram has not to be modified regardless of whether the IP address of the first device is of a custom IP setting or an automatic IP setting. In particular, if a manner of acquiring the IP address by the first device is set to automatically acquire the IP address, when the first device is moved from one physical network to another physical network, any other configuration information has not to be modified, and installation, use and maintenance of the device are simplified.

The decision module 504 is configured to, when intercepting a query request, used to query an internet protocol address, of a second device, determine whether the media access control address of the first device is a media access control address, included in the query request, of a to-be-queried device.

One device is required to acquire an IP address of a correspondent device if communicating with other devices, and thus to transmit a query request of the IP address to the correspondent device. Correspondingly, to acquire the query request, one background service runs on each device, and is used to intercept the query request of the IP address from a designated port.

The second device transmits a query request of querying the IP address, and the MAC address of the to-be-queried device is carried in the query request, and the to-be-queried device is a correspondent device to be communicated with the second device. When the first device intercepts the query request, used to query the IP address, of the second device, it determines whether the MAC address of the first device is the MAC address in the query request.

The transmission module 505 is configured to, if the decision module 504 determines that the media access control address of the first device is a media access control address, included in a query request, of a to-be-queried device, transmit the internet protocol address of the first device to the second device so that the second device communicates with the first device according to the internet protocol address.

If the first device determines that the MAC address of the first device is the MAC address of the to-be-queried device, it transmits the IP address of the first device to the second device, such that the second device may communicate with the first device according to the IP address transmitted by the first device.

If the first device determines that the MAC address of the first device is not the MAC address of the to-be-queried device, the first device disregards it, and continuously intercepts at this port until intercepting the next query request of querying the IP address.

Details, which are not described in detail, of this embodiment refer to the description of the embodiments as previously shown in FIG. 1 to FIG. 4, which will be omitted here.

It is to be noted that, in the above implementation of an addressing communication method based on a media access control address in the example of FIG. 5, all functional modules are divided only by way of example, and may be divided as required in practical application, for example, according to a configuration requirement of corresponding hardware or a convenience purpose of implementing software, the above function assignment is completed by different functional modules, that is, an internal structure of the addressing communication apparatus based on a media access control address is divided into different functional modules so as to complete all or partial functions described as above. Moreover, in the practical application, the corresponding functional modules in this embodiment may be implemented by corresponding hardware, or may be completed by executing corresponding software by corresponding hardware. The individual embodiments provided by this specification may apply the above description rule, which will be omitted hereinafter.

In the embodiment of the disclosure, the MAC address of the device is used as a UID, such that the UID of the device is unique; and the problems that the maintenance cost is high, assigning the IP address easily goes wrong and the system is easily susceptible to failure when the IP address is associated with the UID of the device in the prior art are solved due to unchangeability of the MAC address. Meanwhile, by intercepting a query request, transmitted by other devices, of querying the IP address, and returning the IP address of the device, a normal communication may be kept among the devices, in this way, on the basis of keeping the normal communication, related operations of configuring and maintaining the UID of the device may be simplified, the configuration and maintenance costs are lowered, and the risk of failures in the system is decreased.

With reference to FIG. 6, FIG. 6 is a schematic diagram of a structure of an addressing communication apparatus based on a media access control address according to a fourth embodiment of the disclosure. For ease of illustration, portions related to the embodiment of the disclosure are only shown. The addressing communication apparatus based on a media access control address in the example of FIG. 6 may be an executive main body of an addressing communication method based on a media access control address according to the embodiments as previously shown in FIG. 2 and FIG. 3, such as a second device or a module in the second device. The addressing communication apparatus based on a media access control address in the example of FIG. 6 mainly includes a receiving module 601, a setting module 602, a storage module 603, a decision module 604, a transmission module 605, a communication module 606, a query module 607, an acquisition module 608 and an updating module 609. The above functional modules are described in detail as below.

In particular, the receiving module 601 is configured to receive a binding instruction.

The setting module 602 is configured to set a unique identifier of the first device according to a media access control address of the first device in accordance with the binding instruction.

Further, the setting module 602 is further configured to splice 12 hexadecimal notations in a media access control address of the first device into a 12-bit character string in accordance with a sequence in the media access control address of the first device according to the binding instruction, and use the character string as a unique identifier of the first device, so that the uniqueness of the UID of each device may be guaranteed. For example, the first device has the MAC address of 00:10:23:48:7F:6B, and then the first device has the UID of “001023487F6B”.

The storage module 603 is configured to store an association relation between respective description information, including the unique identifier, of the first device.

The description information refers to information of describing various aspects of attributes of the first device, for example, the description information may be UID information of the first device, or may also be number information used to mark a physical position where the first device is located, or may be specific address information of the first device, and the address information may be specific to a number of a room where the first device is located.

The association relation refers to a correspondence relationship among the UID information, the number information and the address information of the first device.

The decision module 604 is configured to, when intercepting a query request, used to query an internet protocol address, of a second device, determine whether the media access control address of the first device is a media access control address, included in a query request, of a to-be-queried device.

The transmission module 605 is configured to, if the decision module 604 determines that the media access control address of the first device is a media access control address, included in a query request, of a to-be-queried device, transmit the internet protocol address of the first device to the second device so that the second device communicates with the first device according to the internet protocol address.

If the first device determines that the MAC address of the first device is not the MAC address of the to-be-queried device, the first device disregards it, and continuously intercepts at this port until intercepting the next query request of querying the IP address.

The transmission module 605 is further configured to, when there is a need for communicating with a target device, transmit a request of querying an internet protocol address to a plurality of other devices by means of a user datagram protocol multicast, wherein the request includes a media access control address of a to-be-queried target device.

That is, when the first device is required to communicate with a target device, it actively initiates a query for the IP address of the target device.

The apparatus may further include:

A communication module 606, which is configured to receive the internet protocol address replied by the target device, and communicate with the target device by the internet protocol address.

Further, the storage module 603 is further configured to cache a diagram of correspondence relationships between media access control addresses and internet protocol addresses of respective devices.

The setting module 602 is further configured to set ageing periods for the internet protocol addresses in the diagram of correspondence relationships, wherein the ageing periods are used to indicate effective durations of correspondence relationships between the media access control addresses and the internet protocol addresses in the diagram of correspondence relationships.

Last update time of the IP address is also recorded in the diagram of correspondence relationships.

An ageing period is set for an entry of the IP address in the diagram of correspondence relationships, and the ageing period is used to indicate an effective duration of a correspondence relationship between the MAC address and the IP address in the diagram of correspondence relationships, for example, 5 seconds. The IP address in the diagram of correspondence relationships is directly used before the IP address ages, without initiating a query request of the IP address to other devices; and the IP address ages, which indicates that the IP address has been possibly failed relative to its corresponding MAC address, the IP address of the MAC address has to be acquired again, and the query request of the IP address is initiated to the other devices, in this way, the time may be saved, and the occupation of a network flow is decreased.

The apparatus may further include:

a querying module 607, which is configured to, in the pre-cached diagram of correspondence relationships between media access control addresses and internet protocol addresses of respective devices, query whether an internet protocol address corresponding to the media access control address of the target device exists.

Further, the transmission module 605 is further configured to, if the target internet protocol address does not exist, transmit a request of querying the internet protocol address to a plurality of other devices by means of a user datagram protocol multicast.

In particular, UDP multicast may include UDP multicast or UDP broadcast. MAC addresses of the other devices are stored in respective devices; when a query request is transmitted to a plurality of other devices in the same group if IP addresses corresponding to the MAC addresses have to be queried, a MAC address of a to-be-queried device is carried in the request, in this way, when the to-be-queried target device intercepts this request, it determines whether the MAC address in the request is the MAC address of the target device, and if the MAC address in the request is the MAC address of the target device, the IP address of the target device is returned, and if the MAC address in the request is not the MAC address of the target device, the IP address of the target device is disregarded.

The decision module 604 is further configured to, if the target internet protocol address exists, determine whether last update time of the internet protocol address of the target device at a distance from current time is greater than a preset ageing period of the target internet protocol address in the diagram of correspondence relationships.

The transmission module 605 is further configured to, if a determining result of the decision module 604 is that the last update time of the internet protocol address of the target device at a distance from the current time is greater than the ageing period, transmit a request of querying the internet protocol address to a plurality of other devices by means of a user datagram protocol multicast.

The apparatus further includes:

an acquisition module 608, which is configured to, if a determining result of the decision module 604 is that the last update time of the internet protocol address of the target device at a distance from the current time is not greater than the ageing period, acquire an internet protocol address corresponding to the media access control address of the target device from the diagram of correspondence relationships.

An updating module 609, which is configured to update the internet protocol address replied by the target device into an internet protocol address corresponding to the media access control address of the target device in the diagram of correspondence relationships.

Details, which are not described in detail, of this embodiment refer to the description of the embodiments as previously shown in FIG. 1 to FIG. 5, which will be omitted here.

In the embodiments of the disclosure, the MAC address of the device is used as a UID, such that the UID of the device is unique; and the problems that the maintenance cost is high, assigning the IP address easily goes wrong and the system is easily susceptible to failure when the IP address is associated with the UID of the device in the prior art are solved due to unchangeability of the MAC address. Meanwhile, by intercepting a query request, transmitted by other devices, of querying the IP address, and returning the IP address of the device, a normal communication may be kept among the devices, in this way, on the basis of keeping the normal communication, related operations of configuring and maintaining the UID of the device may be simplified, the configuration and maintenance costs are lowered, and the risk of failures in the system is decreased. Further, an ageing period is set for the diagram of correspondence relationships, after the diagram of correspondence relationships ages, a query request of the IP address is initiated to other devices to acquire a new IP address, in this way, the time may be saved, and the occupation of a network flow is decreased.

In multiple embodiments provided by this application, it is to be understood that the disclosed system, apparatus and method may be implemented in other forms. For example, the apparatus embodiments described as above are merely schematic. For example, the division of the module is merely one kind of logic functional division. There may be other division manners in practical implementation, for example, multiple modules or components may be combined or integrated into another system, or some features may be ignored or not executed. Moreover, the displayed or discussed mutual coupling or direct coupling or communication link therebetween may be indirect coupling or communication link through some interfaces, apparatuses or modules, and may be of an electrical form, a mechanical form or other forms.

The modules described as separate components may be or not be physically separated, components displayed as modules may be or not be a physical module, that is, may be located in one place, or may also be distributed on a plurality of network modules. Some or all modules may be selected according to an actual demand to realize an objective of a solution of this embodiment.

In addition, in the individual embodiments of the application, the functional modules may be integrated into one processing module, or the individual functional modules may also be physically exist alone, or two or more of the above modules may be integrated into one module. The above integrated module may be implemented in the form of hardware, or may be implemented in the form of a software functional module.

The integrated module may be stored in one computer readable storage medium if being implemented in the form of the software functional module and sold or used as an independent product. Based on such an understanding, a technical solution of the application essentially or a part, making a contribution to the prior art, of the technical solution, or all or some of the technical solution may be embodied in the form of a software product. The computer software product is stored in one storage medium, including a plurality of instructions, which are used for enabling one computer device (which may be a personal computer, a server, a network device and the like) to execute all or some steps of the method of the individual embodiments of the application. The previous storage medium includes various mediums capable of storing program codes, such as a U disk, a mobile hard disk drive, a read-only memory (ROM), a random access memory (RAM), a magnetic disk or a compact disk.

It is to be noted that, while, for purposes of simplicity of description, the previous method embodiments are shown and described as a series of act combinations, it is to be understood and appreciated by those skilled in the art that the application is not limited by the described order of acts, as some acts may occur in different orders and/or concurrently in accordance with the application. Next, it is also to be understood and appreciated by those skilled in the art that the embodiments described in the specification all belong to preferred embodiments, and the involved acts and modules are not necessarily required by the application.

In the above embodiments, the individual embodiments are laid particular emphasis respectively, and a part which is not described in detail in a certain embodiment may refer to related description of other embodiments.

An embodiment of the disclosure provides a nonvolatile computer storage media having computer executable instructions stored thereon, wherein the computer executable instructions can execute any one of the foregoing addressing communication method based on a media access control address in the disclosure.

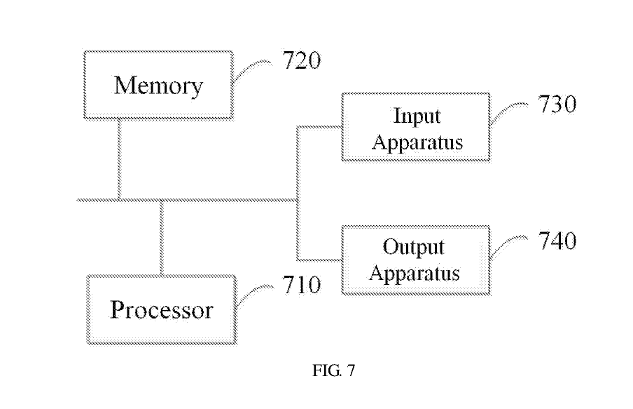

FIG. 7 is a schematic diagram of a structure of an hardware of the device of the addressing communication method based on a media access control address according to another embodiment of the disclosure, as shown in FIG. 7, this device includes:

one or more processors 710 and a memory 720, in FIG. 7, one processors 710 is employed as an example.

The electronic device of the addressing communication method based on a media access control address may further comprise: an input apparatus 730 and an output apparatus 740.

The processor 710, the memory 720, the input apparatus 730 and the output apparatus 740 may be connected via a bus or other means, in FIG. 7, a connection via a bus is taken as an example.

As a nonvolatile computer readable storage media, the memory 720 can be used to store nonvolatile software program, nonvolatile computer executable program and module, such as the program instructions/modules corresponding to the addressing communication method in the embodiments of the present disclosure (e.g., the receiving module 501 and the setting module 502 as shown in FIG. 5). The processor 710 executes various functions and applications of a server and data processing by running a nonvolatile software program, instructions and a module stored in the memory 720, so as to carry out the addressing communication method based on a media access control address in the embodiments above.

The memory 720 may include a program storage area and a data storage area, wherein the program storage area can store an operating system, an application program required for at least one function; the data storage area can store the data created based on the use of the addressing communication device based on a media access control address, or the like. Further, the memory 720 may include high-speed random access memory, and may further include nonvolatile memory, such as at least one disk storage device, flash memory device, or other nonvolatile solid-state memory devices. In some embodiments, the memory 720 optionally includes a memory remotely located with respect to the processor 710, which may be connected to the addressing communication device based on a media access control address via a network. Examples of such network include, but not limited to, Internet, Intranet, local area network (LAN), mobile communication network, and combinations thereof.

The input apparatus 730 may receive the input numbers or characters information, as well as key signal input associated with user settings of the addressing communication device based on a media access control address and function control. The output apparatus 740 may include a display screen or other display device.

The one or more modules are stored in the memory 720, and when being executed by the one or more processors 710, execute the addressing communication method based on a media access control address according to the above embodiments of method.

The above mentioned products can perform the method provided by the embodiments of the present disclosure, and they have the function modules and beneficial effects corresponding to this method. With respect to the technical details that are not detailed in this embodiment, please refer to the methods provided by the embodiments of the present disclosure.

The electronic device according to the embodiments of the present disclosure may have many forms, for example, including, but not limited to:

mobile communication device: the characteristic of such device is: it has the function of mobile communication, and takes providing voice and data communications as the main target. Such type of terminal includes: smart phones (for example iPhone), multimedia phones, feature phones and low-end mobile phones.

ultra mobile PC device: this type of device belongs to the category of personal computer, it has the capabilities of computing and processing, and generally has the feature of mobile Internet access. Such type of terminal includes: PDA, MID and UMPC devices, such as iPad.

portable entertainment device: this type of device can display and play multimedia content. Such type of device includes: audio players (for example iPod), video players, handheld game consoles, e-books, as well as smart toys and portable vehicle navigation devices.

server: it provides computing services, and the structure of the server includes: a processor, a hard disk, a memory, a system bus and the like, its construction is similar to a general computer, but there is higher requirement on the processing capability, stability, reliability, security, scalability, manageability and other aspects of the server as highly reliable service is needed to provide.

other electronic device that has the function of data exchange.

The device of the above described embodiments are merely illustrative, and the unit described as separating member may or may not be physically separated, the component shown as a unit may be or may not be a physical unit, i.e., it may be located at one place, or it can be distributed to a plurality of network units. The aim of this embodiment can be implemented by selecting a part of or all of the modules according to the practical needs. And it can be understood and implemented by those of ordinary skill in the art without paying any creative work.

With reference to the above described embodiments, those skilled in the art can clearly understand that all the embodiments may be implemented by means of using software plus a necessary universal hardware platform, of course, they also be implemented by hardware. Based on this understanding, the above technical solution can be substantially, or the part thereof contributing to the prior art may be, embodied in the form of a software product, and the computer software product may be stored in a computer readable storage medium, such as ROM/RAM, magnetic disc, CD-ROM, or the like, which includes several instructions to instruct a computer device (may be a personal computer, server, or network equipment) to perform the method described in each embodiment or some parts of the embodiment.

Finally, it should be noted that: the above embodiments are merely provided for describing the technical solutions of the present invention, but not intended to limit thereto; although the present invention has been described in detail with reference to the foregoing embodiments, those skilled in the art will appreciate that: they can make modifications to the technical solutions described in the foregoing embodiments, or make equivalent replacements to some technical features thereof; and these modifications or replacements do not make the essence of corresponding technical solutions depart from the spirit and scope of the technical solution of each embodiment.

What is claimed is:

1. An address communication method based on a media access control address, which is applied to a first device, comprising:
receiving a binding instruction, and setting a unique identifier of the first device according to a media access control address in accordance with the binding instruction;
storing an association relation between respective description information, comprising the unique identifier, of the first device;
when intercepting a query request, used to query an internet protocol address, of a second device, determining whether the media access control address of the first device is a media access control address, comprised in the query request, of a to-be-queried device; and
if yes, transmitting an internet protocol address of the first device to the second device so that the second device communicates with the first device according to the internet protocol address.

2. The method according to claim 1, wherein the setting a unique identifier of the first device according to a media access control address in accordance with the binding instruction comprises:
splicing 12 hexadecimal notations in a media access control address of the first device into a 12-bit character string in accordance with a sequence in the media access control address of the first device, and using the character string as a unique identifier of the first device.

3. The method according to claim 1, further comprising:
when there is a need for communicating with a target device, transmitting a request of querying an internet protocol address to a plurality of other devices by means of a user datagram protocol multicast, wherein the request comprises a media access control address of a to-be-queried target device; and
receiving the internet protocol address replied by the target device, and communicating with the target device by the internet protocol address.

4. The method according to claim 3, further comprising:
caching a list of correspondence relationships between media access control addresses and internet protocol addresses of respective devices, and setting ageing periods for the internet protocol addresses in the list of correspondence relationships, wherein the ageing periods are used to indicate effective durations of correspondence relationships between media access control addresses and the internet protocol addresses in the list of correspondence relationships.

5. The method according to claim 4, before the transmitting a request of querying an internet protocol address to a plurality of other devices by means of a user datagram protocol multicast, further comprising:
in the pre-cached list of correspondence relationships between media access control addresses and internet protocol addresses of respective devices, querying whether a target internet protocol address corresponding to a media access control address of the target device exists;
if the target internet protocol address does not exist, performing the step of transmitting a request of querying the internet protocol address to a plurality of other devices by means of a user datagram protocol multicast;
if the target internet protocol address exists, determining whether last update time of the internet protocol address of the target device at a distance from the current time is greater than a preset ageing period of the target internet protocol address in the list of correspondence relationships;
if the last update time is greater than the ageing period, performing the step of transmitting a request of querying the internet protocol address to a plurality of other devices by means of a user datagram protocol multicast; and
if the last update time is not greater than the ageing period, acquiring an internet protocol address corresponding to the media access control address of the target device from the list of correspondence relationships, and communicating with the target device according to the acquired internet protocol address.

6. The method according to claim 5, after receiving an internet protocol address replied by the target device, further comprising:
updating an internet protocol address replied by the target device into an internet protocol address corresponding to the media access control address of the target device in the list of correspondence relationships.

7. A nonvolatile computer storage media, which has computer executable instructions stored thereon, wherein the computer executable instructions are configured to:
receive a binding instruction, and set a unique identifier of the first device according to a media access control address in accordance with the binding instruction;
store an association relation between respective description information, comprising the unique identifier, of the first device;
when intercepting a query request, used to query an internet protocol address, of a second device, determine whether the media access control address of the first device is a media access control address, comprised in the query request, of a to-be-queried device; and
if yes, transmit an internet protocol address of the first device to the second device so that the second device communicates with the first device according to the internet protocol address.

8. The nonvolatile computer storage media according to claim 7, wherein the step to set a unique identifier of the first device according to a media access control address in accordance with the binding instruction comprises:
splice 12 hexadecimal notations in a media access control address of the first device into a 12-bit character string in accordance with a sequence in the media access control address of the first device, and use the character string as a unique identifier of the first device.

9. The nonvolatile computer storage media according to claim 7, wherein the computer executable instructions are further configured to:
when there is a need for communicating with a target device, transmit a request of querying an internet protocol address to a plurality of other devices by means of a user datagram protocol multicast, wherein the request comprises a media access control address of a to-be-queried target device; and
receive the internet protocol address replied by the target device, and communicate with the target device by the internet protocol address.

10. The nonvolatile computer storage media according to claim 9, wherein the computer executable instructions are further configured to:
cache a list of correspondence relationships between media access control addresses and internet protocol addresses of respective devices, and set ageing periods for the internet protocol addresses in the list of correspondence relationships, wherein the ageing periods are used to indicate effective durations of correspondence relationships between media access control addresses and the internet protocol addresses in the list of correspondence relationships.

11. The nonvolatile computer storage media according to claim 10, wherein the computer executable instructions are further configured to,
before the transmit a request of querying an internet protocol address to a plurality of other devices by means of a user datagram protocol multicast,
in the pre-cached list of correspondence relationships between media access control addresses and internet protocol addresses of respective devices, query whether a target internet protocol address corresponding to a media access control address of the target device exists;
if the target internet protocol address does not exist, perform the step of transmit a request of querying the internet protocol address to a plurality of other devices by means of a user datagram protocol multicast;
if the target internet protocol address exists, determine whether last update time of the internet protocol address of the target device at a distance from the current time is greater than a preset ageing period of the target internet protocol address in the list of correspondence relationships;
if the last update time is greater than the ageing period, perform the step of transmit a request of querying the internet protocol address to a plurality of other devices by means of a user datagram protocol multicast; and
if the last update time is not greater than the ageing period, acquire an internet protocol address corresponding to the media access control address of the target device from the list of correspondence relationships, and communicate with the target device according to the acquired internet protocol address.

12. The nonvolatile computer storage media according to claim 11, wherein the computer executable instructions are further configured to:
after receiving an internet protocol address replied by the target device,
update an internet protocol address replied by the target device into an internet protocol address corresponding to the media access control address of the target device in the list of correspondence relationships.

13. An electronic device, comprising:
one or more processors; and,
a memory; wherein,
one or more programs, wherein the one or more programs are stored in the memory, and when being executed by the one or more processors, perform:
receiving a binding instruction, and setting a unique identifier of the first device according to a media access control address of the first device in accordance with the binding instruction;
storing an association relation between respective description information, comprising the unique identifier, of the first device;
when intercepting a query request, used to query an internet protocol address, of a second device, determining whether the MAC address of the first device is a media access control address, comprised in the query request, of a to-be-queried device; and
if yes, transmitting the internet protocol address of the first device to the second device so that the second device communicates with the first device according to the internet protocol address.

14. The electronic device according to claim 13, wherein the setting a unique identifier of the first device according to a media access control address of the first device comprises:
splicing 12 hexadecimal notations in a media access control address of the first device into a 12-bit character string in accordance with a sequence in the media access control address of the first device, and using the character string as a unique identifier of the first device.

15. The electronic device according to claim 13, further comprising:
when there is a need for communicating with a target device, transmitting a request of querying an internet protocol address to a plurality of other devices by means of a user datagram protocol multicast, wherein the request comprises a media access control address of a to-be-queried target device; and
receiving the internet protocol address replied by the target device, and communicating with the target device by the internet protocol address.

16. The electronic device according to claim 15, further comprising:
caching a list of correspondence relationships between media access control addresses and internet protocol addresses of respective devices, and setting ageing periods for the internet protocol addresses in the list of correspondence relationships, wherein the ageing periods are used to indicate effective durations of correspondence relationships between media access control addresses and the internet protocol addresses in the list of correspondence relationships.

17. The electronic device according to claim 16, before the transmitting a request of querying an internet protocol address to a plurality of other devices by means of a user datagram protocol multicast, further comprising:
in the pre-cached list of correspondence relationships between media access control addresses and internet protocol addresses of respective devices, querying whether a target internet protocol address corresponding to a media access control address of the target device exists;
if the target internet protocol address does not exist, performing the step of transmitting a request of querying the internet protocol address to a plurality of other devices by means of a user datagram protocol multicast;
if the target internet protocol address exists, determining whether last update time of the internet protocol address of the target device at a distance from the current time is greater than a preset ageing period of the target internet protocol address in the list of correspondence relationships;
if the last update time is greater than the ageing period, performing the step of transmitting a request of querying the internet protocol address to a plurality of other devices by means of a user datagram protocol multicast; and
if the last update time is not greater than the ageing period, acquiring an internet protocol address corresponding to the media access control address of the target device from the list of correspondence relationships, and communicating with the target device according to the acquired internet protocol address.

18. The electronic device according to claim 17, after receiving an internet protocol address replied by the target device, further comprising:
updating an internet protocol address replied by the target device into an internet protocol address corresponding to the media access control address of the target device in the list of correspondence relationships.
